(19) United States
(12) Patent Application Publication
(10) Pub. No.: US 2014/0225048 A1
(43) Pub. Date: Aug. 14, 2014

(54) LIQUID COMPOSITION, AND COLOR-FILTER RESIST COMPOSITION, THERMAL-TRANSFER RECORDING SHEET AND INK WHICH MAKE USE OF THE LIQUID COMPOSITION

(71) Applicants: Satoshi Saito, Mishima-shi (JP); Taichi Shintou, Saitama-shi (JP); Takayuki Ujifusa, Ashigarakami-gun (JP); Yutaka Tani, Yokohama-shi (JP); Masao Nakano, Kamakura-shi (JP); Kaoru Takahashi, Saitama-shi (JP); Takeshi Miyazaki, Ebina-shi (JP); Masashi Hirose, Machida-shi (JP)

(72) Inventors: Satoshi Saito, Mishima-shi (JP); Taichi Shintou, Saitama-shi (JP); Takayuki Ujifusa, Ashigarakami-gun (JP); Yutaka Tani, Yokohama-shi (JP); Masao Nakano, Kamakura-shi (JP); Kaoru Takahashi, Saitama-shi (JP); Takeshi Miyazaki, Ebina-shi (JP); Masashi Hirose, Machida-shi (JP)

(73) Assignee: CANON KABUSHIKI KAISHA, Tokyo (JP)

(21) Appl. No.: 14/129,468

(22) PCT Filed: Jul. 24, 2012
(86) PCT No.: PCT/JP2012/069272

§ 371 Date: Dec. 26, 2013

(30) Foreign Application Priority Data
Jul. 27, 2011 (JP) 2011-163861

(51) Int. Cl. G02B 1/04; G02B 5/23

(52) U.S. Cl. CPC G02B 1/04; G02B 5/23
USPC 252/586

(57) ABSTRACT

It is aimed to provide a liquid composition having a high solubility in solvents, high brightness and chroma, and spectral reflection characteristics with a broad color range. It is a liquid composition characterized by having a medium and a compound represented by the following general formula (1).

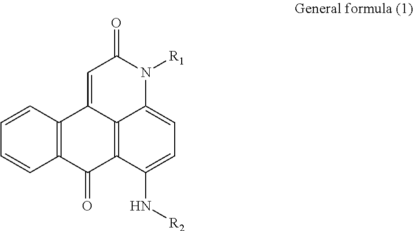

In the general formula (1), R₁ and R₂ each represent an alkyl group, and either one of these represents an alkyl group having 7 or more carbon atoms.

### TECHNICAL FIELD

The present invention relates to a liquid composition used in producing coating materials, inks, toners, color filters, thermal-transfer recording sheets, resin molded products and so forth, and a method for its production. The present invention also relates to a color-filter resist composition (resist composition for color filters) having the liquid composition as a colorant, and to a thermal-transfer recording sheet and a method for its production.

### BACKGROUND ART

In recent years, color images including color liquid-crystal displays have become extensively popular, and there is an increasing demand for the achievement of higher image quality. The color filter is necessary and indispensable for the color displaying of liquid-crystal displays, and is an important component part that influences the performance of liquid-crystal displays. As conventional methods for producing color filters, a dying method, a printing method, an ink-jet method, a photoresist method and the like are known in the art. In particular, in recent years, the photoresist method has become prevalent in the production methods, because it can make it easy to control spectral characteristics and secure reproducibility, and enables high-precision patterning on account of a high resolution.

In this photoresist method, pigments are commonly used as colorants. However, the pigments are, as having certain particle diameter, known to be accompanied by depolarization (which means that polarized light is destroyed) to lower the contrast ratio of color display of a liquid-crystal display. Also, in a system where any pigment is used, it is difficult to attain a high transmittance for the light of back lighting, and there is a limit on how the color filter is improved in brightness. Further, the pigments are insoluble in organic solvents and polymers, and hence it is difficult for a colored resist composition, which is obtained as a disperse system, to be made stably dispersed.

In contrast thereto, dyes are commonly soluble in organic solvents and polymers, and are stable even in the colored resist composition without causing any agglomeration. Hence, in a color filter obtained from a resist composition making use of any dye as the colorant, the dye can be free of any depolarization because it stands dispersed at the molecular level, and promises an excellent transmittance for the light of back lighting.

Hitherto, in order to enable image display having good spectral characteristics and a high display contrast, a red color filter is reported which makes use of a monoazo coloring matter C.I. Acid Red 6 (see PTL 1). With progress of broadband communications, in order to display images having a higher definition, it is sought to make development of a color filter that can materialize good spectral characteristics and a high contrast ratio.

### CITATION LIST

### Patent Literature

PTL 1: Japanese Patent Application Laid-open No. 2003-005351

### SUMMARY OF INVENTION

### Technical Problem

The present invention aims to resolve the above problems.

More specifically, it is an object of the present invention to provide a liquid composition having a high solubility in solvents, high brightness and chroma, and spectral reflection characteristics with a broad color range. It is also an object of the present invention to provide a color-filter resist composition, a thermal-transfer recording sheet and an ink which make use of such a liquid composition.

### Solution to Problem

The above objects can be achieved by the invention described below.

That is, the present invention provides a liquid composition characterized by having a medium and contained therein at least a compound represented by the following general formula (1).

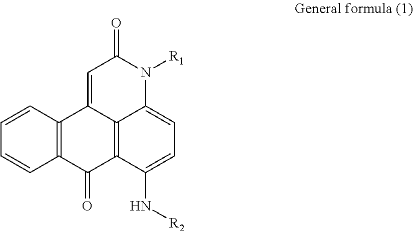

In the general formula (1), R₁ and R₂ each represent an alkyl group or an alkoxyalkyl group, and either one of R₁ and R₂ at least has 7 or more carbon atoms.

### Advantageous Effects of Invention

According to the present invention, a liquid composition can be provided which has a high solubility in solvents, high brightness and chroma, and spectral reflection characteristics with a broad color range. Further, the use of such a liquid composition can provide a color-filter resist composition, a thermal-transfer recording sheet and an ink which have a good red color tone.

### BRIEF DESCRIPTION OF DRAWINGS

FIG. 1 is a chart showing a ¹H-NMR spectrum in CDCl₃, at room temperature and at 400 MHz, of a compound (2) in the present invention, included in what is represented by the general formula (1).

### DESCRIPTION OF EMBODIMENTS

The present invention is described below in detail by giving embodiments for its working. The present inventors have made extensive studies in order to resolve the above problems the prior art has had. As the result, they have discovered that a liquid composition can be obtained which has a high solubility in solvents, high brightness and chroma, and spectral reflection characteristics with a broad color range. They have also discovered that a color-filter resist composition, a thermal-transfer recording sheet and an ink can be provided which make use of the liquid composition obtained. Thus, they have accomplished the present invention.

The liquid composition of the present invention is characterized by having a medium and a compound represented by the following general formula (1) as a colorant.

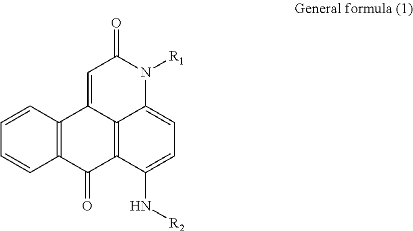

In the general formula (1), R₁ and R₂ each represent an alkyl group or an alkoxyalkyl group, and either one of R₁ and R₂ at least has 7 or more carbon atoms.

The alkyl group represented by R₁ and R₂ each in the general formula (1) may include, but not particularly limited to, e.g., straight-chain, branched-chain or cyclic alkyl groups having 1 to 20 carbon atoms, such as a methyl group, an ethyl group, a propyl group, a butyl group, an octyl group, a dodecyl group, a nonadecyl group, a cyclobutyl group, a cyclopentyl group, a cyclohexyl group, a methylcyclohexyl group and an ethylhexyl group. As the alkyl group having 7 or more carbon atoms, a branched-chain alkyl group such as a 2-ethylhexyl group is preferable in view of the high solubility in solvents. A branched-chain alkyl group having 8 or more carbon atoms is more preferable.

The alkoxyalkyl group (—R—O—R′) represented by R₁ and R₂ each in the general formula (1) may include, but not particularly limited to, e.g., a 3-butoxypropyl group and a 3-(2-ethylhexyloxy)propyl group. These are particularly preferable in view of the high solubility in solvents.

The R₁ and R₂ groups may each further have a substituent. The substituent may include, but not particularly limited to, e.g., aryl groups such as a phenyl group; monosubstituted amino groups such as a methylamino group and a propylamino group; and disubstituted amino groups such as a dimethylamino group, a dipropylamino group and an N-ethyl-N-phenyl group.

The compound represented by the general formula (1) according to the present invention may be synthesized by a known method.

About how to produce the compound represented by the general formula (1) according to the present invention, an embodiment thereof is shown below, to which, however, how to produce it is by no means limited.

That is, a compound A may be acetylated with acetic anhydride to obtain a compound B. This is further cyclized to obtain a compound C. The compound C and an amine compound are subjected to condensation to obtain the compound represented by the general formula (1) according to the present invention. Also, in respect of the functional group of each compound, any known reaction such as protection-deprotection reaction or hydrolysis may optionally be added; this is a matter of appropriate selection for those skilled in the art.

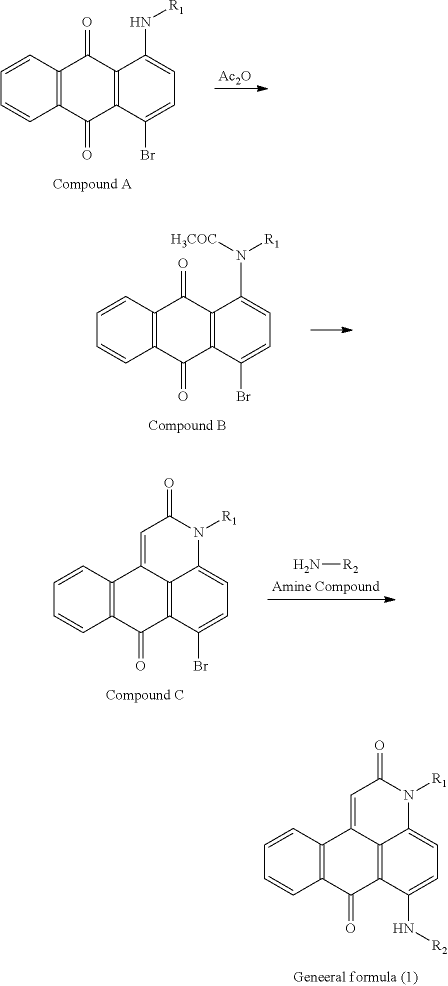

The compound represented by the general formula (1) in the present invention may be used alone or in combination of two or more types, or in combination of two or more types, with a known magenta pigment or dye.

<Liquid Composition>

As the liquid medium constituting the liquid composition of the present invention, there are no particular limitations thereon as long as it can disperse or dissolve the compound represented by the general formula (1). It may preferably be water or an organic solvent.

The liquid composition of the present invention is obtained by dispersing or dissolving in the liquid medium the compound represented by the general formula (1).

The liquid composition of the present invention is obtained, e.g., in the following way. The compound represented by the general formula (1) and optionally a resin are put into the liquid medium, and, to the mixture obtained, a mechanical shear force may optionally be applied by means of a dispersion machine to make up a uniform solution.

The dispersion machine that may be used in the present invention may include, but not particularly limited to, e.g., media dispersion machines such as a rotary shearing homogenizer, a ball mill, a sand mill and an attritor, and a high-pressure counter impact type dispersion machine, any of which may preferably be used.

In the liquid composition of the present invention, the compound represented by the general formula (1) may be in a content of from 1.0 part by mass to 30.0 parts by mass, preferably from 2.0 parts by mass to 20.0 parts by mass, and much preferably from 3.0 parts by mass to 15.0 parts by mass, based on 100 parts by mass of the liquid medium. If the compound represented by the general formula (1) is in a too small content, the compound may have a low coloring power. If it is in a too large content, the compound may partly remain not dissolved in the solvent, and hence may make color developability poor.

In the present invention, the liquid composition may be dispersed in water by using an emulsifying agent in order to attain a good dispersion stability. The emulsifying agent may include, but not particularly limited to, e.g., cationic surface active agents, anionic surface active agents and nonionic surface active agents.

Such a cationic surface active agent used as the emulsifying agent used in the present invention may include, but not particularly limited to, e.g., dodecylammonium chloride, dodecylammonium bromide, dodecyltrimethylammonium bromide, dodecylpyridinium chloride, dodecylpyridinium bromide and hexadecyltrimethylammonium bromide.

The anionic surface active agent may also include fatty acid soaps such as sodium stearate and sodium dodecanoate, and sodium dodecyl sulfate, sodium dodecylbenzene sulfate and sodium lauryl sulfate.

Further, the nonionic surface active agent may include, but not particularly limited to, e.g., dodecyl polyoxyethylene ether, hexadecyl polyoxyethylene ether, nonyl polyoxyethylene ether, lauryl polyoxyethylene ether, sorbitan monooleate polyoxyethylene ether, and monodecanoyl sucrose.

The organic solvent usable as the liquid medium for the liquid composition of the present invention, it may be chosen in accordance with use purposes of the colorant, and there are no particular limitations thereon. Stated specifically, it may include alcohols such as methyl alcohol, ethyl alcohol, modified ethyl alcohol, isopropyl alcohol, n-butyl alcohol, isobutyl alcohol, tert-butyl alcohol, sec-butyl alcohol, tert-amyl alcohol, 3-pentanol, octyl alcohol, benzyl alcohol and cyclohexanol; glycols such as methyl Cellosolve, ethyl Cellosolve, diethylene glycol and diethylene glycol monobutyl ether; ketones such as acetone, methyl ethyl ketone and methyl isobutyl ketone; esters such as ethyl acetate, butyl acetate, ethyl propionate and Cellosolve acetate; hydrocarbon type solvents such as hexane, octane, petroleum ether, cyclohexane, benzene, toluene and xylene; halogenated hydrocarbon type solvents such as carbon tetrachloride, trichloroethylene and tetrabromoethane; ethers such as diethyl ether, dimethyl glycol, trioxane and tetrahydrofuran; acetals such as methylal and diethylaceatal; organic acids such as formic acid, acetic acid and propionic acid; and sulfur- or nitrogen-containing organic compounds such as nitrobenzene, dimethylamine, monoethanolamine, pyridine, dimethyl sulfoxide and dimethyl formamide.

As the organic solvent used in the present invention, a polymerizable monomer may also be used. The polymerizable monomer is an addition polymerizable monomer or a condensation polymerizable monomer, and may preferably be the addition polymerizable monomer. Stated specifically, it may include styrene monomers such as styrene, o-methylstyrene, m-methylstyrene, p-methylstyrene, o-ethylstyrene, m-ethylstyrene and p-ethylstyrene; acrylate monomers such as methyl acrylate, ethyl acrylate, propyl acrylate, butyl acrylate, octyl acrylate, dodecyl acrylate, stearyl acrylate, behenyl acrylate, 2-ethylhexyl acrylate, dimethylaminoethyl acrylate, diethylaminoethyl acrylate, acrylonitrile and acrylic acid amide; methacrylate monomers such as methyl methacrylate, ethyl methacrylate, propyl methacrylate, butyl methacrylate, octyl methacrylate, dodecyl methacrylate, stearyl methacrylate, behenyl methacrylate, 2-ethylhexyl methacrylate, dimethylaminoethyl methacrylate, diethylaminoethyl methacrylate, methacrylonitrile and methacrylic acid amide; olefinic monomers such as ethylene, propylene, butylene, butadiene, isoprene, isobutylene and cyclohexene; vinyl halides such as vinyl chloride, vinylidene chloride, vinyl bromide and vinyl iodide; vinyl esters such as vinyl acetate, vinyl propionate and vinyl benzoate; vinyl ethers such as methyl vinyl ether, ethyl vinyl ether and isobutyl vinyl ether; and vinyl ketones such as methyl vinyl ketone, hexyl vinyl ketone and isopropenyl vinyl ketone. Any of these may be used alone or in combination of two or more types in accordance with use purposes. Of the above polymerizable monomers, styrene or any of styrene monomers may preferably be used alone or in the form of a mixture with other polymerizable monomer where the liquid composition of the present invention is used for the purpose of a polymerization toner. In particular, styrene is preferred in view of readiness in handling.

A resin may further be added to the liquid composition. As the resin usable in the liquid composition, it may be chosen in accordance with its use purposes, and there are no particular limitations thereon. Stated specifically, it may include, e.g., polystyrene resin, styrene copolymers, polyacrylic acid resin, polymethacrylic acid resin, polyacrylate resin, polymethacrylate resin, acrylate copolymers, methacrylate copolymers, polyester resin, polyvinyl ether resin, polyvinyl methyl ether resin, polyvinyl alcohol resin and polyvinyl butyral resin. Besides, it may include polyurethane resin and polypeptide resin. Any of these resins may be used alone or in the form of a mixture of two or more types.

As the colorant [the compound represented by the general formula (1)] constituting the liquid composition of the present invention, any other colorant may be used in combination as long as the dispersibility of the liquid composition of the present invention is not inhibited. The colorant that may be used in combination may include, e.g., various compounds as typified by condensation azo compounds, anthraquinone compounds, azo metal complexes, methine compound and allylamide compounds.

The liquid composition of the present invention has a high solubility in solvents and a vivid color tone, and, in virtue of its excellent spectral characteristics, may be used as a magenta colorant, preferably, as a material for recoding image information. For example, where the liquid medium is a water system, it may be used as a colorant for inks for ink-jet recording, water-based inks for printing, water-based paints, and water-based inks for stationery. Also, where the liquid medium is an organic solvent system, it may be used as a colorant for resist compositions for color filters, oil-based inks for printing, oil-based paints, and oil-based inks for stationery.

<Color-Filter Resist Composition>

The liquid composition of the present invention has a vivid red color tone, and, in virtue of its spectral characteristics, may be used as a coloring matter for red color, and preferably as a colorant for color filters.

When the liquid composition of the present invention is used to prepare the color-filter resist composition, it may be used in combination with any other colorant to make up a resist composition having any desired color. It, however, is preferable to make up a red resist composition without use in combination with such other colorant, or with use in combination with any other colorant in such a quantity that may not inhibit the color tone of the liquid composition of the present invention.

The resist composition of the present invention is composed of at least a binder resin, a photopolymerizable monomer, a photopolymerization initiator, a solvent and one or more types of the liquid composition of the present invention.

In a color filter having a substrate and adjoiningly arranged thereon two types or more of pixels having different spectral characteristics, the liquid composition of the present invention may be used in at least one of such a plurality of pixels (of, e.g., red, green and blue), whereby pixels having high transparency and high color purity can be obtained. It may further be mixed with a dye so as to be improved in spectral characteristics, and hence a mixture of the liquid composition of the present invention and the dye may be used. The dye may arbitrarily be used in the form of a mixture of two or more types in order to obtain the desired hue.

The resist composition of the present invention may preferably contain the compound represented by the general formula (1), in an amount of from 0.01% by mass to 400% by mass, and much preferably from 0.1% by mass to 200% by mass, based on the mass of the following binder resin.

As the binder resin usable in the color-filter resist composition of the present invention, it may at least be what can make exposed-to-light areas or light-screened areas dissolve with use of an organic solvent, an aqueous alkali solution, water or a commercially available developing solution, and there are no particular limitations thereon. Further, water or one having composition that enables alkali development may be much preferable from the viewpoint of workability, waste disposal and so forth.

Such a binder resin is commonly known to include binder resins obtained by copolymerizing a hydrophilic monomer as typified by acrylic acid, methacrylic acid, 2-hydroxyethyl, acrylamide, N-vinylpyrrolidone or a monomer having an ammonium salt and a lipophilic monomer as typified by acrylate, methacrylate, vinyl acetate, styrene or N-vinylcarbazole in an appropriate mixing ratio and by a known method. Any of these binder resins may be used as a resist of a negative type, i.e., a type that light-screened areas are removed by development, in combination with a radically polymerizable monomer having an ethylenically unsaturated group, a cationically polymerizable monomer having an oxirane ring or oxetane ring, or a radical-generating agent, an acid-generating agent or a radical-generating agent.

A binder resin may also be used which is typified by tert-butyl carbonate of polyhydroxystyrene, tert-butyl ester, tetrahydroxypyranyl ester or tetrahydroxypyranyl ether. The binder resin of this type may be used as a resist of a positive type, i.e., a type that exposed-to-light areas are removed by development, in combination with an acid-generating agent.

The color-filter resist composition of the present invention contains a photopolymerizable monomer having one or more ethylenically unsaturated double bond(s), as a monomer having an ethylenically unsaturated double bond, which undergoes addition polymerization upon exposure to light.

The photopolymerizable monomer may include compounds having in the molecule at least one additionally polymerizable ethylenically unsaturated group and having a boiling point of 100° C. or more at normal pressure. For example, it may include monofunctional acrylates such as polyethylene glycol monoacrylate, polyethylene glycol monomethacrylate, polypropylene glycol monoacrylate, polypropylene glycol monomethacrylate, phenoxyethyl acrylate and phenoxyethyl methacrylate; polyfunctional acrylates or methacrylates such as polyethylene glycol diacrylate, polyethylene glycol dimethacrylate, polypropylene glycol diacrylate, polypropylene glycol dimethacrylate, trimethylolethane triacrylate, trimethylolethane trimethacrylate, trimethylolpropane triacrylate, trimethylolpropane trimethacrylate, trimethylolpropane diacrylate, trimethylolpropane dimethacrylate, neopentyl glycol diacrylate, neopentyl glycol dimethacrylate, pentaerythritol tetraacrylate, pentaerythritol tetramethacrylate, pentaerythritol triacrylate, pentaerythritol trimethacrylate, dipentaerythritol hexaacrylate, dipentaerythritol hexamethacrylate, dipentaerythritol pentaacrylate, dipentaerythritol pentamethacrylate, hexanediol diacrylate, hexanediol dimethacrylate, trimethylolpropane tri(acryloyloxypropyl)ether, tri(acryloyloxyethyl) isocyanurate, tri(acryloyloxyethyl) cyanurate, glycerol triacrylate and glycerol trimethacrylate; and polyfunctional acrylates or polyfunctional methacrylates, such as those obtained by the addition of ethylene oxide or propylene oxide to a polyfunctional alcohol such as trimethylolpropane or glycerol, followed by acrylation or methacrylation.

It may further include polyfunctional acrylates or methacrylates such as urethane acrylates, polyester acrylates, and epoxy acrylates that are reaction products of epoxy resins and acrylic acid or methacrylic acid. Of the foregoing, trimethylolpropane triacrylate, trimethylolpropane trimethacrylate, pentaerythritol tetraacrylate, pentaerythritol tetramethacrylate, dipentaerythritol hexaacrylate, dipentaerythritol hexamethacrylate, dipentaerythritol pentaacrylate and dipentaerythritol pentamethacrylate are preferred.

The photopolymerizable monomer having two or more ethylenically unsaturated double bonds may be used alone or may be used in the form of a mixture of two or more types. The photopolymerizable monomer may commonly be in a content of 5% by mass to 50% by mass, and particularly preferably from 10% by mass to 40% by mass, based on the mass (total solid matter) of the color-filter resist composition.

The color-filter resist composition of the present invention is, where it is ultraviolet-curable, so made up as to contain a photopolymerization initiator. The photopolymerization initiator may include vicinal polyketoaldonyl compounds, α-carbonyl compounds, acyloin ethers, various quinone compounds, a combination of triallyimidazole dimer with p-aminophenyl ketone, and trioxadiazole compounds, and may preferably include 2-benzyl-2-dimethylamino-1-(4-morpholinophenyl)butanone (trade name: IRGACURE 369; available from BASF Corp.). Incidentally, where electron rays are used in forming pixels by using the color-filter resist composition of the present invention, the photopolymerization initiator is not essential.

The color-filter resist composition of the present invention contains a solvent in which the binder resin, the photopolymerizable monomer, the photopolymerization initiator, the colorant and so forth are to be dissolved or dispersed. The solvent that may be used may include cyclohexanone, ethyl Cellosolve acetate, butyl Cellosolve acetate, 1-methoxy-2-propyl acetate, diethylene glycol dimethyl ether, ethylbenzene, 1,2,4-trichlorobenzene, ethylene glycol diethyl ether, xylene, ethyl Cellosolve, methyl-n-amyl ketone, propylene glycol monomethyl ether, toluene, methyl ethyl ketone, ethyl acetate, methanol, ethanol, isopropyl alcohol, butanol, isobutyl ketone, and petroleum type solvents. Any of these may be used alone or in the form of a mixture.

As described above, the color-filter resist composition of the present invention is so made up as to contain the liquid composition of the present invention as the colorant, and hence the pixels formed can have a good hue and be improved in transparency and light transmission properties.

### <Ink>

The liquid composition of the present invention may be used as an ink. Particularly preferred is a case in which the liquid medium is a water system. A mixed solvent of water and a water-soluble organic solvent may also be used. As the water-soluble organic solvent used in such a case, there are no particular limitations thereon as long as it exhibits water-solubility, and it may include, e.g., alcohols, polyhydric alcohols, polyethylene glycol, glycol ether, nitrogen-containing polar solvents and sulfur-containing polar solvents.

Where such an ink containing the liquid composition of the present invention is prepared, there are no particular limitations on the pH of the ink, which, however, may preferably be an ink having a pH within the range of from 4.0 to 1.0 taking account of safety. Also, where an ink for ink-jet recording is prepared, a moisture-retentive solid matter such as urea, a urea derivative or trimethylol propane may be used as a component of the ink in order to maintain the retentivity of the ink. The moisture-retentive solid matter such as urea, a urea derivative or trimethylol propane in the ink may commonly be in a content in the range of from 0.1% by mass or more to 20.0% by mass or less, and much preferably from 3.0% by mass or more to 10.0% by mass or less, based on the mass of the ink.

Further, in making up the ink, besides the above components, it may optionally be incorporated with various additives such as a pH adjuster, a rust preventive, an antiseptic agent, a mildew-proofing agent, an antioxidant, a reduction preventive, an evaporation accelerator, a chelating agent and a water-soluble polymer.

As described above, the ink containing the liquid composition of the present invention is particularly preferably used in an ink-jet recording system which performs recording by ejecting ink droplets by the action of heat energy. The ink containing the liquid composition of the present invention may, needless to say, also be used as an ink used in any other ink-jet recording systems and as a material for commonly available stationery and so forth.

### <Thermal-Transfer Recording Sheet>

The thermal-transfer recording sheet of the present invention has a base material and a coloring material layer, and is characterized by containing in the coloring material layer the liquid composition of the present invention. In the thermal-transfer recording sheet of the present invention, together with the liquid composition of the present invention, any coloring matter compound may be used in combination as long as it does not greatly affect the brightness and chroma.

The thermal-transfer recording sheet of the present invention may usually be produced by coating a base material base film with a “liquid composition for thermal-transfer recording sheet” prepared by dissolving, or dispersing in the state of fine particles, the liquid composition of the present invention in a medium together with a binder, and then drying the wet coating formed. The thermal-transfer recording sheet of the present invention is by no means limited to the one produced by this method.

The binder used to prepare the liquid composition for thermal-transfer recording sheet may include various resins. In particular, preferred are water-soluble reins such as a cellulose type, an acrylic acid type, a starch type an epoxy type; and also resins soluble in organic solvents, such as acrylic resin, methacrylic resin, polystyrene, polycarbonate, polyether sulfone, polyvinyl butyral, ethyl cellulose, acetyl cellulose, polyester, AS resin and phenoxy resin. Any of these resins may be used alone or in combination of two or more types. In this liquid composition, such a binder and the compound represented by the general formula (1) may be used in a ratio (binder:coloring matter compound) of from 1:2 to 2:1 in mass ratio as an appropriate range.

The medium used to prepare the liquid composition for thermal-transfer recording sheet may include, besides water, various organic solvents. In particular, preferred are alcohols such as methyl alcohol, ethyl alcohol, isopropyl alcohol and isobutyl alcohol; Cellosolves such as methyl Cellosolve and ethyl Cellosolve; aromatics such as toluene, xylene and chlorobenzene; esters such as ethyl acetate and butyl acetate; ketones such as acetone, methyl ethyl ketone, methyl isobutyl ketone and cyclohexanone; chlorine type solvents such as methylene chloride, chloroform and trichloroethylene; ethers such as tetrahydrofuran and dioxane; and N,N-dimethyl formamide, N-methyl-pyrrolidone and the like. Any of these organic solvents may be used alone or in the form of a mixture of two or more types.

In the present invention, to the above liquid composition for the thermal-transfer recording sheet, organic or inorganic non-sublimable fine particles, a dispersant, an antistatic agent, an anti-foaming agent, an antioxidant, a viscosity modifier and so forth may optionally be added.

As the base film that is the base material to be coated with the liquid composition for thermal-transfer recording sheet, there by no means be any particular limitations thereon. Preferred are, e.g., sheets of thin paper such as capacitor tissue paper or glassine paper, and films of well heat-resistant plastics such as polyester, polycarbonate, polyamide, polyimide and polyaramid. The base material may preferably have a thickness of from 3 μm to 50 μm. Of the base films, polyethylene terephthalate film is particularly preferable in view of mechanical strength, solvent resistance and economical advantages.

Further, in the present invention, for the purpose of improving heat resistance and thermal-head run performance, it is preferable that a layer of: a lubricant, highly lubricating heat-resistant fine particles, a surface active agent or a binder or the like heat-resistant resin is provided on the opposite surface of the base material on which the coloring material layer is formed. Such a lubricant may include amino-modified silicone compounds and carboxy-modified silicone compounds, the heat-resistant fine particles may include fine particles such as silica, and the binder may include acrylic resins.

As a method of coating the base film with the liquid composition for thermal-transfer recording sheet, there are no particular limitations thereon, and it may include, e.g., methods making use of a bar coater, a gravure coater, a reverse roll coater, a rod coater, an air doctor coater and the like. The liquid composition for thermal-transfer recording sheet may preferably be so applied as for the coloring material layer to have a thickness in the range of from 0.1 μm to 5 μm after it has been dried.

Further, as a heating means for heating the thermal-transfer recording sheet of the present invention, there are no particular limitations thereon. For example, not only a thermal head, but also infrared rays or laser beams may be used. Also, an electrification heat-generating film which generates heat by flowing electricity through the base film itself may be used so that the thermal-transfer recording sheet of the present invention may be used as an electrification type dye transfer sheet.

### EXAMPLES

The present invention is described below in greater detail by giving Examples and Comparative Examples, to which Examples, however, the present invention is by no means limited. In the following, what are noted as “part(s)” and “%” are by mass unless particularly noted. Reaction products obtained were identified by a plurality of analytical methods making use of instruments shown below. That is, as instruments used, a ¹H_{and} ¹³C nuclear magnetic resonance spectroscopic analyzer (ECA-400, manufactured by JEOL Ltd.), a mass spectrometric analyzer LC/TOF MS (LC/MSD TOF, manufactured by Agilent Technologies Inc.) and a UV/Vis spectrophotometer (UV-36000-model spectrophotometer, manufactured by Shimadzu Corporation) were used. Here, the ionization in the LC/TOF MS made use of the electrospray ionization method (ESI).

Production of compound represented by the general formula (1):

The compound represented by the general formula (1) may also be produced by a known method.

The compound represented by the general formula (1) was produced by the method described below.

As to Compound (1), the commercially available compound is used.

### Production Example 1

### Production Example of Compound (2)

102 g of acetic anhydride was added to a 20 g 1,2-dichlorobenzene solution of 76.9 g of 4-bromo-1-cyclohexylaminoanthraquinone, and 1 g of concentrated sulfuric acid was also added thereto, where these were stirred at 110° C. for 6 hours. After the reaction was completed, the reaction product obtained was diluted with 1,000 g of methanol, and then filtered to obtain 59.8 g of 1-(acetylcyclohexylamino)-4-bromoanthraquinone (yield: 70.1%).

Further, to a 150 g isobutanol solution of the 1-(acetylcyclohexylamino)-4-bromoanthraquinone, a solution of 12 g of sodium hydroxide and 150 g of water was dropwise added, and these were stirred at 90° C. for 6 hours. After the reaction was completed, the reaction product obtained was cooled and then the solid obtained was filtered to obtain 28.7 g of 4-bromo-1,9-N-cyclohexylanthrapyridone (yield: 70.4%).

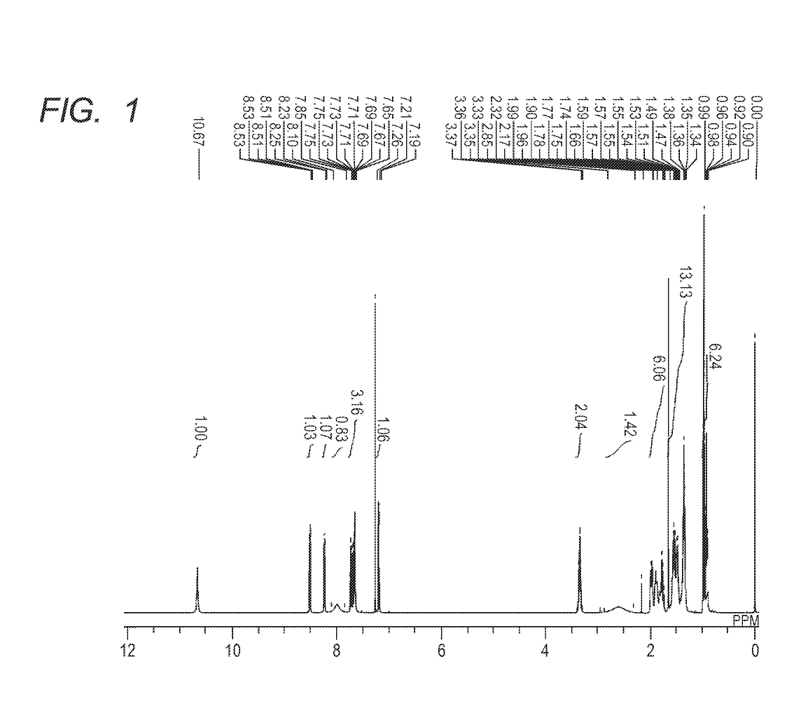

Next, into a 40 g 1,3-dimethyl-2-imidazolidine solution of 20.4 g of the 4-bromo-1,9-N-cyclohexylanthrapyridone, 25.8 g of 2-ethylhexylamine, 8.6 g of sodium carbonate and 6.8 g of copper powder were introduced, and these were allowed to react at 190° C. for 4 hours. After the reaction was completed, the reaction product obtained was cooled, which was then diluted with ethyl acetate, and then filtered. The product obtained was purified by column chromatography (toluene/THF) to obtain 18 g of a compound (2) (yield: 82.7%). A ¹H NMR spectrum in CDCl₃, at room temperature and at 400 MHz of this compound (2) is shown in FIG. 1.

Results of Analysis on Compound (2):

[1] ¹H NMR (400 MHz, CDCl₃, room temperature):

δ [ppm]=0.95 (td, 3H, J=15.1, 7.79 Hz), 1.34-1.59 (m, 11H), 1.66 (s, 2H), 1.87 (tt, 6H, J=41.7, 10.5 Hz), 3.35 (dt, 2H, J=16.2, 6.53 Hz), 7.20 (d, 1H, J=10.1 Hz), 7.65-7.75 (m, 3 Hz), 8.00 (s, 1H), 8.24 (d, 1H, J=7.79 Hz), 8.52 (dd, 1H, J=7.79, 1.37 Hz), 10.7 (s, 1H)

[2] Mass spectrometry (ESI-TOF): m/z=457.2850 (M+H)⁺

Production Examples of Other dye Compounds:

Other compounds shown in Table 1 below were each synthesized by the procedure according to Production Example 1. The structure of these compounds each was identified in the same way as the compound described above.

Results of Analysis on Compound (3):

[1] ¹H NMR (400 MHz, CDCl₃, room temperature):

δ [ppm]=0.97 (tt, 8H, J=20.8, 7.17 Hz), 1.36 (dd, 4H, J=9.16, 5.50 Hz), 1.48-1.60 (m, 5H), 1.64 (s, 2H), 1.78 (dt, 3H, J=20.2, 6.98 Hz), 3.34-3.39 (m, 2H), 4.42 (t, 2H, J=7.79 Hz), 7.25 (t, 2H, J=6.18 Hz), 7.65-7.76 (m, 4 Hz), 8.24 (d, 1H, J=7.79 Hz), 8.53 (dd, 1H, J=7.79, 1.37 Hz), 10.7 (s, 1H)

[2] Mass spectrometry (ESI-TOF): m/z=430.9556 (M+H)⁺

Results of Analysis on Compound (4):

[1] ¹H NMR (400 MHz, CDCl₃, room temperature):

δ [ppm]=0.91 (td, 6H, J=14.7, 7.48 Hz), 1.29-1.58 (m, 12H), 1.68 (s, 2H), 1.90 (dd, 3H, J=21.5, 7.79 Hz), 2.14 (t, 2H, J=13.5 Hz), 3.66 (s, 1H), 4.37 (s, 2H), 7.25 (t, 1H, J=6.87 Hz), 7.63-7.76 (m, 4 Hz), 8.24 (d, 1H, J=7.79 Hz), 8.51 (dd, 1H, J=8.01, 1.60 Hz), 10.7 (d, 1H, J=7.79 Hz)

[2] Mass spectrometry (ESI-TOF): m/z=456.8830 (M+H)⁺

Results of Analysis on Compound (5):

[1] ¹H NMR (400 MHz, CDCl₃, room temperature):

δ [ppm]=0.93 (tt, 12H, J=19.7, 7.48 Hz), 1.29-1.60 (m, 15H), 1.76 (td, 2H, J=13.5, 7.94 Hz), 1.92 (t, 1H, J=6.18 Hz), 3.35 (dt, 2H, J=15.9, 6.41 Hz), 4.36 (s, 2H), 7.21 (d, 1H, J=9.62 Hz), 7.64-7.75 (m, 4 Hz), 8.23 (d, 1H, J=7.33 Hz), 8.52 (dd, 1H, J=7.79, 1.37 Hz), 10.7 (s, 1H)

[2] Mass spectrometry (ESI-TOF): m/z=487.9323 (M+H)⁺

Results of Analysis on Compound (6):

[1] ¹H NMR (400 MHz, CDCl₃, room temperature):

δ [ppm]=0.98 (dt, 6H, J=35.7, 7.33 Hz), 1.35-1.64 (m, 8H), 1.75-1.82 (m, 2H), 2.02-2.09 (m, 2H), 3.46 (t, 2H, J=6.64 Hz), 4.42 (t, 2H, J=7.79 Hz), 7.28 (t, 2H, J=8.47 Hz), 7.70 (ddd, 4 Hz, J=25.3, 11.8, 5.61 Hz), 8.25 (d, 1H, J=7.79 Hz), 8.51 (t, 1H, J=4.58 Hz), 10.6 (s, 1H)

[2] Mass spectrometry (ESI-TOF): m/z=433.2524 (M+H)⁺

Results of Analysis on Compound (7):

[1] ¹H NMR (400 MHz, CDCl₃, room temperature):

δ [ppm]=0.86-0.90 (m, 6H), 1.02 (t, 3H, J=7.33 Hz), 1.34 (ddd, 8H, J=30.3, 17.1, 6.75 Hz), 1.62 (s, 3H), 1.79 (t, 2H, J=7.79), 2.05 (t, 2H, J=6.18 Jz), 3.34 (d, 2H, J=5.95 Hz), 3.54-3.60 (m, 4H), 4.42 (t, 2H, J=7.79 Hz), 7.29 (t, 1H, J=9.16 Hz), 7.70 (dq, 4 Hz, J=24.8, 6.03 Hz), 8.25 (d, 1H, J=7.79 Hz), 8.51 (dd, 1H, J=8.01, 1.60 Hz), 10.6 (s, 1H)

[2] Mass spectrometry (ESI-TOF): m/z=489.3205 (M+H)⁺

Results of Analysis on Compound (8):

[1] ¹H NMR (400 MHz, CDCl₃, room temperature):

δ [ppm]=0.88 (t, 3H, J=6.87 Hz), 1.02 (t, 3H, J=7.33 Hz), 1.20-1.30 (m, 16H), 1.53 (m, 4H), 1.80 (dt, 4H, J=15.5, 8.55), 3.43 (q, 2H, J=6.41 Hz), 4.43 (t, 2H, J=7.79 Hz), 7.24 (t, 1H, J=7.10 Hz), 7.66-7.77 (m, 4 Hz), 8.25 (d, 1H, J=7.33 Hz), 8.52 (dd, 1H, J=7.79, 1.37 Hz), 10.6 (s, 1H)

[2] Mass spectrometry (ESI-TOF): m/z=487.3319 (M+H)⁺

Results of Analysis on Compound (9):

[1] ¹H NMR (400 MHz, CDCl₃, room temperature):

δ [ppm]=1.02 (t, 3H, J=7.33 Hz), 1.48-1.81 (m, 8H), 2.04 (t, 4H, J=7.56 Hz), 2.42 (t, 2H, J=7.10 Hz), 3.48 (dd, 2H, J=12.4, 7.33 Hz), 4.39 (t, 2H, J=7.79 Hz), 5.65 (s, 1H), 7.21 (d, 1H, J=9.62 Hz), 7.68 (tt, 4 Hz, J=17.2, 7.40 Hz), 8.21 (d, 1H, J=8.24 Hz), 8.49 (d, 1H, J=7.79 Hz), 10.5 (s, 1H)

### [2] Mass spectrometry (ESI-TOF): m/z=427.2431 (M+H)⁺

Results of Analysis on Compound (10):

[1] ¹H NMR (400 MHz, CDCl₃, room temperature):

δ [ppm]=1.01 (t, 3H, J=7.33 Hz), 1.51 (dd, 2H, J=15.1, 7.33 Hz), 7.75 (t, 2H, J=6.87), 2.13 (t, 2H, J=7.33 Hz), 8.84 (t, 2H, J=7.56 Hz), 3.39 (q, 2H, J=6.41 Hz), 4.35 (d, 2H, J=7.79 Hz), 7.09 (d, 1H, J=9.62 Hz), 7.23 (t, 3H, J=6.64 Hz), 7.31 (t, 2H, J=7.56 Hz), 7.57 (d, 1H, J=9.62 Hz), 7.62-7.73 (m, 3 Hz), 8.18 (d, 1H, J=7.79 Hz), 8.47 (d, 1H, J=6.41 Hz), 10.6 (s, 1H)

[2] Mass spectrometry (ESI-TOF): m/z=437.2225 (M+H)⁺

Production of Liquid Composition:

Liquid compositions of the present invention and comparative liquid compositions were produced by the methods described below.

### Example 1

17 parts of the compound (1) and 120 parts of styrene were mixed, and the mixture obtained was put to dispersion for 1 hour by means of an attritor (manufactured by Mitsui Mining and Smelting Co., Ltd.) to obtain a liquid composition (1) of the present invention.

### Examples 2 to 10

Liquid compositions (2) to (10) were obtained in the same way as Example 1 except that, in Example 1, the compound (1) was changed for the compounds (2) to (10), respectively.

### Comparative Examples 1 to 5

Comparative liquid compositions (1) to (5) were obtained in the same way as Example 1 except that, in Example 1, the compound (1) was changed for comparative compounds (1) to (5), respectively, having structures shown below.

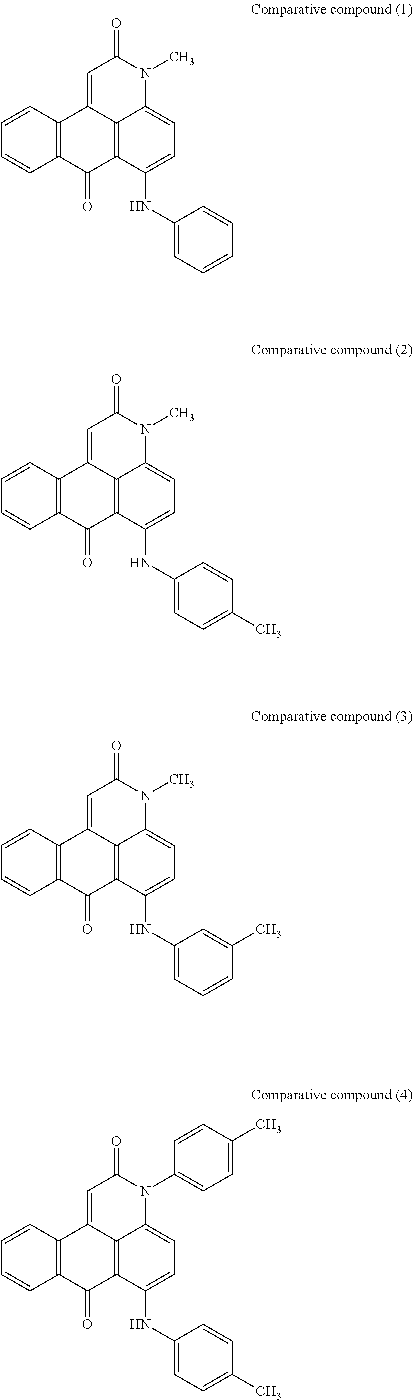 [SMILES: Cn1c(=O)cc2c3c(c(Nc4ccccc4)ccc31)C(=O)c1ccccc1-2 ; Cc1ccc(Nc2ccc3c4c(cc(=O)n3C)-c3ccccc3C(=O)c24)cc1 ; Cc1cccc(Nc2ccc3c4c(cc(=O)n3C)-c3ccccc3C(=O)c24)c1 ; Cc1ccc(Nc2ccc3c4c(cc(=O)n3-c3ccc(C)cc3)-c3ccccc3C(=O)c24)cc1]

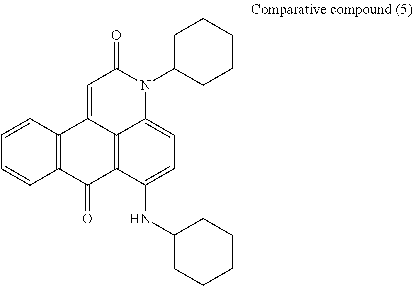 [SMILES: O=C1c2ccccc2-c2cc(=O)n(C3CCCCC3)c3ccc(NC4CCCCC4)c1c23]

### Evaluation

### Examination of Solubility of Compounds

The compounds (1) to (10) and the comparative compounds (1) to (5) were each dissolved in toluene at room temperature to make evaluation of their solubility. Where the solubility in toluene was 5% or more, the compound was judged to have a high compatibility with resin.

A: The solubility in toluene is 10% or more (the solubility is very good).

B: The solubility in toluene is 3% or more to less than 10% (the solubility is good).

C: The solubility in toluene is less than 3% (the solubility is poor).

Color Tone Evaluation:

Color tone was evaluated in the following way. The liquid compositions (1) to (10) of the present invention and the comparative liquid compositions (1) to (5) were each applied on an opacity measuring sheet by bar coating (bar No. 10), and the coatings formed were air-dried overnight. Their optical density and chromaticity (L*, a*, b*) in the L*a*b* color system were measured with a reflection densitometer SPECTROLINO (manufactured by Gretag Macbeth Holding AG). Chroma (C*) was calculated according to the following equation on the basis of the measured values of color characteristics.

C*=\sqrt{(a*)²+(b*)²}

The evaluation was made in the following way. The larger the C* in equal L* is, the better the color tone can be said to be. It was evaluated by the value of C* found when the L* was 50.

A: The C* is 85 or more (the color tone is very good). B: The C* is 65 or more to less than 85 (the color tone is good).

C: The C* is less than 65 (the color tone is poor).

Coloring Power Evaluation:

The liquid compositions (1) to (10) of the present invention and the comparative liquid compositions (1) to (5) were each applied on an opacity measuring sheet by bar coating (bar No. 10), as the pigment quantity per unit area (5 cm×5 cm) was 6.5 mg. Then the coatings formed were air-dried overnight. Their optical density and chromaticity (L*, a*, b*) in the L*a*b* color system were measured with a reflection densitometer SPECTROLINO (manufactured by Gretag Macbeth Holding AG). Chroma (C*) was calculated according to the above equation on the basis of the measured values of color characteristics.

The evaluation was made in the following way. The larger the C* in pigment quantity per equal unit area is, the higher the coloring power can be said to be. It was evaluated by the value of C* found when.

A: The C* is 80 or more (the coloring power is very high).

B: The C* is 70 or more to less than 80 (the coloring power is high).

C: The C* is less than 70 (the coloring power is low).

Synthesis examples of the dye compounds synthesized as described above and the results of measurement of their wavelengths are summarized in Table 1; and the results of evaluation of the solubility of compounds and evaluation of the liquid compositions of Examples and Comparative Examples, in Table 2. Each asterisk * in the compounds shown in Table 1 represents the position of bonding of the substituent.

TABLE 1

| Synthesis | | | | |
|---|---|---|---|---|
| example | Compound | R₁ | R₂ | λex |
| 1 | (1) | CH₃ | 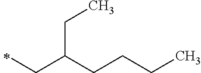 | 548 |
| 2 | (2) | 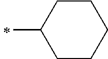 | 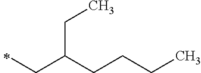 | 546 |
| 3 | (3) | n-Bu | 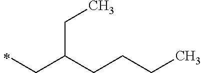 | 547 |
| 4 | (4) | 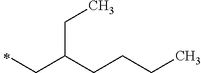 | 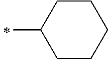 | 550 |
| 5 | (5) | 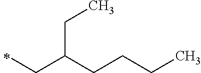 | 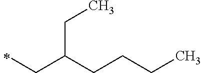 | 549 |
| 6 | (6) | n-Bu | 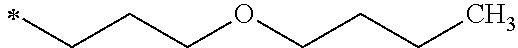 | 544 |
| 7 | (7) | n-Bu | 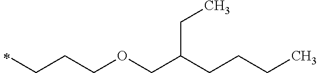 | 544 |
| 8 | (8) | n-Bu | 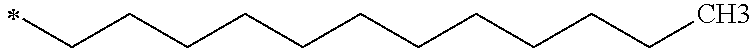 | 545 |
| 9 | (9) | n-Bu | 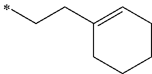 | 544 |
| 10 | (10) | n-Bu | 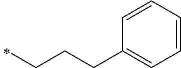 | 547 |

TABLE 2

| | | | Evaluation | | | | | | | |
|---|---|---|---|---|---|---|---|---|---|---|
| | | | | | | | | | Coloring | |
| | Com- | Solu- | Solu- | Color tone | | | | | power | |
| | pound | bility | bility | L* | a* | b* | C* | Rank | C* | Rank |
| Example: | | | | | | | | | | |
| 1 | (1) | 5% | B | 49.7 | 81.9 | 12.5 | 82.8 | B | 83.6 | A |
| 2 | (2) | 10% | A | 50.0 | 85.1 | 43.8 | 95.8 | A | 86.8 | A |
| 3 | (3) | 10% | A | 50.2 | 84.6 | 26.0 | 88.5 | A | 86.5 | A |
| 4 | (4) | 10% | A | 49.9 | 84.5 | 31.7 | 90.2 | A | 86.6 | A |
| 5 | (5) | ≧10% | A | 49.9 | 84.0 | 28.5 | 88.7 | A | 85.4 | A |
| 6 | (6) | 10% | A | 50.1 | 82.0 | 37.7 | 90.3 | A | 84.8 | A |
| 7 | (7) | ≧10% | A | 50.1 | 82.2 | 36.2 | 89.8 | A | 83.2 | A |
| 8 | (8) | ≧10% | A | 50.1 | 85.3 | 10.9 | 86.0 | A | 84.0 | A |
| 9 | (9) | ≧10% | A | 49.9 | 80.3 | 31.8 | 86.4 | A | 84.1 | A |
| 10 | (10) | 10% | A | 49.9 | 86.4 | 0.4 | 86.4 | A | 82.2 | A |
| Comparative | | | | | | | | | | |
| Example: | | | | | | | | | | |
| 1 | (1) | ≦1% | C | 49.6 | 40.9 | −18.2 | 44.8 | C | 55.3 | C |
| 2 | (2) | ≦1% | C | 50.7 | 32.8 | −13.9 | 35.6 | C | 44.1 | C |
| 3 | (3) | ≦1% | C | 48.2 | 24.5 | −25.2 | 35.1 | C | 45.3 | C |
| 4 | (4) | ≦1% | C | 50.2 | 40.7 | −9.7 | 41.9 | C | 43.7 | C |
| 5 | (5) | ≦0.1% | C | 52.2 | 81.3 | 48.2 | 94.5 | A | 66.0 | C |

As is clear from Tables 1 and 2, the liquid compositions obtained in the present invention have a higher solubility in solvent, higher brightness and chroma, and spectral reflection characteristics with a broader color range, than the contrasting comparative liquid compositions.

### Preparation of Red-Color Resist Composition

### Example 11

12 parts of the compound (3) was mixed with 120 parts of cyclohexanone, and the mixture obtained was put to dispersion for 1 hour by means of an attritor (manufactured by Mitsui Mining and Smelting Co., Ltd.) to obtain a liquid composition (11).

22 parts of the liquid composition (11) obtained was slowly added to a 96 parts cyclohexanone solution of 6.7 parts of an acrylic copolymer composition, 1.3 parts of dipentaerythritol pentamethacrylate and 0.4 part of 2-benzyl-2-dimethylamino-1-(4-morpholinophenyl)-butanone-1 (photopolymerization initiator), and these were stirred at room temperature for 3 hours. The mixture obtained was filtered with a filter of 1.5 μm in pore size to obtain a red-color resist composition (1).

### Example 12

A liquid composition (12) was prepared, and a red-color resist composition (2) was prepared using it, in the same way as Example 11 except that, in Example 11, the compound (3) was changed for the compound (6).

### Comparative Examples 6 & 7

Comparative liquid compositions (6) and (7) were prepared, and comparative red-color resist compositions (1) and (2) were prepared using them, respectively, in the same way as Example 11 except that, in Example 11, the compound (3) was changed for the comparative compounds (1) and (5), respectively.

Each red-color resist composition obtained as above was applied on a glass sheet by spin coating, and thereafter the wet coating formed was dried at 90° C. for 3 minutes and exposed to light over the whole area to effect post-curing at 180° C. to prepare coated samples (1) and (2) and comparative coated samples (1) and (2), for use in evaluation.

### Preparation of Ink

### Example 13

A mixture of 6 parts of the compound (4) and 1.2 parts of sodium dodecyl sulfate was mixed with 60 parts of water, and the mixture obtained was put to dispersion for 1 hour by means of an attritor (manufactured by Mitsui Mining and Smelting Co., Ltd.) to obtain a liquid composition (13) of the present invention. To 74 parts of this liquid composition (13), 1 part of ACETYLENOL EH (agent available from Kawaken Fine Chemicals Co., Ltd.), 7.5 parts of ethylene glycol, 7.5 parts of glycerol and 7.5 parts of urea were further added, and these were sufficiently stirred to prepare an ink.

The ink obtained as above was applied on a glass sheet by spin coating, followed by drying to prepare a coated sample (3).

### Example 14

A liquid composition (14) was prepared in the same way as Example 13 except that, in Example 13, the compound (4) was changed for the compound (7). Using this, an ink was likewise prepared to prepare a coated sample (4)

### Comparative Example 8

A comparative liquid composition (8) was prepared in the same way as Example 13 except that, in Example 13, the compound (4) was changed for the comparative compound (2). Using this, a comparative ink was likewise prepared to prepare a comparative coated sample (3).

### Preparation of Thermal-Transfer Recording Sheet

### Example 15

To a 45 parts methyl ethyl ketone/45 parts toluene mixed solution of 5 parts of the compound (5), 5 parts of polyvinyl butyral resin (DENKA 3000-K, available from Denki Kagaku Kogyo Kabushikikaisha) was little by little added with stirring to obtain a liquid composition (15).

The liquid composition (15) was so applied onto a 4.5 μm thick polyethylene terephthalate film (LUMILAR, available from Toray Industries, Inc.) as to come to be 1 μm in thickness after drying, followed by drying to produced a thermal-transfer recording sheet (1).

### Example 16

A liquid composition (16) was prepared in the same way as Example 15 except that, in Example 15, the compound (5) was changed for the compound (8). Using this, a thermal-transfer recording sheet (2) was likewise produced.

### Comparative Example 9

A comparative liquid composition (9) was prepared in the same way as Example 15 except that, in Example 15, the compound (5) was changed for the comparative compound (4). Using this, a comparative thermal-transfer recording sheet (1) was likewise produced.

Evaluation of Color Tone of Images Formed on Photographic Paper:

The thermal-transfer recording sheets (1) and (2) and comparative thermal-transfer recording sheet (1) produced as above were each cut and stuck to the magenta portion of an ink cassette for CP710 (manufactured by CANON INC.), and images were formed on photographic paper for exclusive use by using a photo printer SELPHY CP710 (manufactured by CANON INC.). The images were magenta monochrome solid images, and the respective images were taken as transferred images and comparative transferred images. About each of these transferred images, their chromaticity (L*, a*, b*) in the L*a*b* color system were measured with a reflection densitometer SPECTROLINO (manufactured by Gretag Macbeth Holding AG). Chroma (C*) was calculated according to the above equation on the basis of the measured values of color characteristics.

Color Tone Evaluation:

The evaluation was made in the following way. The larger the C* in equal L* is, the better the brightness can be said to be. It was evaluated by the value of C* found when the L* was 50.

A: The C* is 85 or more (the color tone is very good).

B: The C* is 65 or more to less than 85 (the color tone is good).

C: The C* is less than 65 (the color tone is poor).

The results of evaluation are shown together in Table 3.

TABLE 3

| | | Color tone evaluation | | | | | |
|---|---|---|---|---|---|---|---|
| | Evaluation sample | L* | a* | b* | C* | Rank | Use |
| Example: | | | | | | | |
| 11 | Coated sample (1) | 50.4 | 84.6 | 25.9 | 88.5 | A | Resist composition |
| 12 | Coated sample (2) | 50.1 | 81.3 | 36.6 | 89.2 | A | Resist composition |
| 13 | Coated sample (3) | 49.9 | 84.8 | 31.6 | 90.5 | A | Ink |
| 14 | Coated sample (4) | 49.9 | 82.6 | 35.9 | 90.1 | A | Ink |
| 15 | Thermal-transfer | 49.9 | 84.0 | 28.5 | 88.7 | A | Thermal-transfer |
| | recording sheet (1) | | | | | | recording sheet |
| 16 | Thermal-transfer | 50.1 | 84.5 | 11.2 | 85.2 | A | Thermal-transfer |
| | recording sheet (2) | | | | | | recording sheet |
| Comparative | | | | | | | |
| Example: | | | | | | | |
| 6 | Comparative | 48.3 | 40.8 | −18.3 | 44.7 | C | Resist composition |
| | coated sample (1) | | | | | | |
| 7 | Comparative | 50.3 | 39.8 | −9.9 | 41.0 | C | Resist composition |
| | coated sample (2) | | | | | | |
| 8 | Comparative | 50.7 | 32.9 | −12.9 | 35.3 | C | Ink |
| | Coated sample (3) | | | | | | |
| 9 | Comparative | 50.4 | 40.6 | −9.4 | 41.6 | C | Thermal-transfer |
| | thermal-transfer | | | | | | recording sheet |
| | recording sheet (1) | | | | | | |

As is clear from Table 3, the color-filter red-color resist compositions, inks and thermal-transfer recording sheets obtained in the present invention have higher brightness and chroma, and spectral reflection characteristics with a broader color range, than those making use of the contrasting comparative liquid compositions.

### INDUSTRIAL APPLICABILITY

According to the present invention, the liquid composition can be obtained which has a high solubility in solvents, high brightness and chroma, and spectral reflection characteristics with a broad color range. By the use of this liquid composition, a coating composition can be obtained which has superior coating performance for coating finish appearance, physical properties and so forth, and moreover can be made high in density. Further, by the use of this liquid composition, an ink composition can be obtained which has good color developability and dispersion stability and has superior sharpness, transparency, color developability and so forth. The liquid composition of the present invention can also be used as a colorant for toners, inks for ink-jet recording and color filters and as a coloring matter for thermal-transfer recording sheets and optical recording mediums.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-163861, filed Jul. 27, 2011, which is hereby incorporated by reference herein in its entirety.

1. A liquid composition which comprises a liquid medium and a compound represented by the following general formula (1). 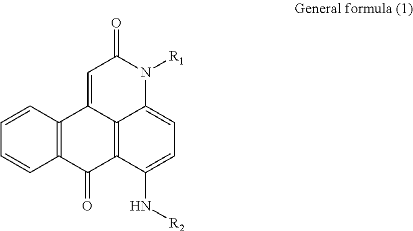
wherein R₁ and R₂ each represent an alkyl group or an alkoxyalkyl group, and either one of R₁ and R₂ at least has 7 or more carbon atoms.

2. The liquid composition according to claim 1, wherein either one of R₁ and R₂ in the general formula (1) is a 2-ethylhexyl group.

3. The liquid composition according to claim 1, wherein either one of R₁ and R₂ in the general formula (1) is a 3-butoxypropyl group or a 3-(2-ethylhexyloxy)propyl group.

4. A color-filter resist composition which comprises the liquid composition according to claim 1.

5. A thermal-transfer recording sheet which comprises a base material and provided on the base material a coloring material layer formed by using at least one type of the liquid composition according to claim 1.

6. An ink which comprises at least one type of the liquid composition according to claim 1.
